(19) United States
(12) Patent Application Publication
(10) Pub. No.: US 2016/0308824 A1
(43) Pub. Date: Oct. 20, 2016

(54) METHOD FOR DETERMINING GRE TUNNEL, GATEWAY DEVICE, AND ACCESS SITE

(71) Applicant: HUAWEI TECHNOLOGIES CO., LTD., Shenzhen (CN)

(72) Inventor: Qi YI, Beijing (CN)

(73) Assignee: HUAWEI TECHNOLOGIES CO., LTD., Shenzhen (CN)

(21) Appl. No.: 15/196,489

(22) Filed: Jun. 29, 2016

Related U.S. Application Data
(63) Continuation of application No. PCT/CN2013/090982, filed on Dec. 30, 2013.

(51) Int. Cl. H04L 29/12; H04L 12/801

(52) U.S. Cl. CPC H04L 61/2015; H04L 47/12; H04W 88/16

(57) ABSTRACT

Embodiments of the present invention provide a method for determining a GRE tunnel, a gateway device, and an access site, 1, so that the access site determines a generic routing encapsulation GRE tunnel of the terminal according to the gateway IP address. According to the method for determining a GRE tunnel, the gateway device, and the access site in the embodiments of the present invention, the gateway device assigns, to a connected terminal, a gateway IP address that is different from an IP address of the gateway device, which can effectively reduce load of the gateway device.

### CROSS-REFERENCE TO RELATED APPLICATIONS

This application is a continuation of International Patent Application No. PCT/CN2013/090982, filed on Dec. 30, 2013, which is hereby incorporated by reference in its entirety.

### TECHNICAL FIELD

Embodiments of the present invention relate to the communications field, and more specifically, to a method for determining a GRE tunnel, a gateway device, and an access site.

### BACKGROUND

In an existing networking method for deploying a generic routing encapsulation (GRE) application in a wireless local area network (WLAN), after being started, an access point (AP) acquires a gateway IP address corresponding to a Wi-Fi gateway from an access controller (AC) by using a Dynamic Host Configuration Protocol (DHCP) procedure, and the gateway IP address remains unchanged thereafter. Therefore, for different terminals that access a same AP, only a same GRE tunnel can be provided, and when a large quantity of users access the gateway device, the same Wi-Fi gateway bears heavy load. In addition, in the prior art, the GRE tunnel between the AP/AC and the Wi-Fi GW does not support dynamic negotiation, and can only be configured on the AC/AP, or can only be assigned to the AP by the AC.

Therefore, a new method for determining a GRE tunnel needs to be put forward, so as to reduce load of a gateway device.

### SUMMARY

Embodiments of the present invention provide a method for determining a GRE tunnel, a gateway device, and an access site, and a gateway IP address that is different from an IP address of the gateway device is assigned to a connected terminal by using the gateway device, which can effectively reduce load of the gateway device.

According to a first aspect, a method for determining a GRE tunnel is provided, where the method includes: receiving, by a first gateway device, a Dynamic Host Configuration Protocol DHCP request packet sent by an access site, where the DHCP request packet is used to request assignment of an Internet Protocol IP address to a terminal that accesses the access site; when determining that load of the first gateway device exceeds a preset threshold, determining a gateway IP address that is different from an IP address of the first gateway device; and sending a DHCP response packet to the access site, where the DHCP response packet includes the gateway IP address and a terminal IP address assigned to the terminal, so that the access site determines a generic routing encapsulation GRE tunnel of the terminal according to the gateway IP address.

With reference to the first aspect, in a first possible implementation manner of the first aspect, the determining a gateway IP address that is different from an IP address of the first gateway device includes:

determining an IP address of a second gateway device as the gateway IP address.

With reference to the first aspect, in a second possible implementation manner of the first aspect, the first gateway device includes a gateway control plane component and a gateway data plane component, the IP address of the first gateway device is an IP address of the gateway control plane component, and the gateway IP address that is different from the IP address of the first gateway device is an IP address of the gateway data plane component.

According to a second aspect, a method for determining a GRE tunnel is provided, where the method includes: sending a Dynamic Host Configuration Protocol DHCP request packet to a first gateway device, where the DHCP request packet is used to request assignment of an IP address to a terminal that accesses an access site; receiving a DHCP response packet sent by the first gateway device, where the DHCP response packet includes a gateway IP address and a terminal IP address assigned to the terminal, and the gateway IP address is different from an IP address of the first gateway device; and determining a generic routing encapsulation GRE tunnel of the terminal according to the gateway IP address in the DHCP response packet.

With reference to the second aspect, in a first possible implementation manner of the second aspect, before the receiving a DHCP response packet sent by the first gateway device, the method further includes: determining the IP address of the first gateway device as a first endpoint IP address of the GRE tunnel of the terminal; and determining an IP address of the access site as a second endpoint IP address of the GRE tunnel of the terminal; and the determining a generic routing encapsulation GRE tunnel of the terminal includes: redetermining a first endpoint IP address of the GRE tunnel of the terminal according to the DHCP response packet, where the redetermined first endpoint IP address of the GRE tunnel is the gateway IP address; and determining the GRE tunnel of the terminal according to the redetermined first endpoint IP address of the GRE tunnel and the second endpoint IP address of the GRE tunnel.

With reference to the second aspect or the first possible implementation manner of the second aspect, in a second possible implementation manner of the second aspect, the method further includes: associating the terminal IP address of the terminal with the gateway IP address, so that when the terminal accesses the access site next time, the GRE tunnel of the terminal is determined according to the gateway IP address.

With reference to the second aspect or any possible implementation manner of the first and the second possible implementation manner of the second aspect, in a third possible implementation manner of the second aspect, the gateway IP address is an IP address of a second gateway device.

With reference to the second aspect or any possible implementation manner of the first to the third possible implementation manners of the second aspect, in a fourth possible implementation manner of the second aspect, the first gateway device includes a gateway control plane component and a gateway data plane component, the IP address of the first gateway device is an IP address of the gateway control plane component, and the gateway IP address is an IP address of the gateway data plane component.

According to a third aspect, a gateway device is provided, where the gateway device includes: a receiving module, configured to receive a Dynamic Host Configuration Protocol DHCP request packet sent by an access site, where the DHCP request packet is used to request assignment of an Internet Protocol IP address to a terminal that accesses the access site; a determining module, configured to: when determining that load of the gateway device exceeds a preset threshold, determine a gateway IP address that is different from an IP address of the gateway device; and a sending module, configured to send a DHCP response packet to the access site, where the DHCP response packet includes the gateway IP address and a terminal IP address assigned to the terminal, so that the access site determines a generic routing encapsulation GRE tunnel of the terminal according to the gateway IP address.

With reference to the third aspect, in a first possible implementation manner of the third aspect, the determining module is specifically configured to determine an IP address of a second gateway device as the gateway IP address.

With reference to the third aspect, in a second possible implementation manner of the third aspect, the first gateway device includes a gateway control plane component and a gateway data plane component, an IP address of the first gateway device is an IP address of the gateway control plane component, and the gateway IP address that is different from the IP address of the first gateway device is an IP address of the gateway data plane component.

According to a fourth aspect, an access site is provided, where the access site includes: a sending module, configured to send a Dynamic Host Configuration Protocol DHCP request packet to a first gateway device, where the DHCP request packet is used to request assignment of an IP address to a terminal that accesses the access site; a receiving module, configured to receive a DHCP response packet sent by the first gateway device, where the DHCP response packet includes a gateway IP address and a terminal IP address assigned to the terminal, and the gateway IP address is different from an IP address of the first gateway device; and a determining module, configured to determine a generic routing encapsulation GRE tunnel of the terminal according to the gateway IP address in the DHCP response packet.

With reference to the fourth aspect, in a first possible implementation manner of the fourth aspect, the determining module is further configured to: before the receiving module receives the DHCP response packet sent by the first gateway device, determine the IP address of the first gateway device as a first endpoint IP address of the GRE tunnel of the terminal; the determining module is further configured to determine an IP address of the access site as a second endpoint IP address of the GRE tunnel of the terminal; the determining module is further specifically configured to redetermine a first endpoint IP address of the GRE tunnel of the terminal according to the DHCP response packet, where the redetermined first endpoint IP address of the GRE tunnel is the gateway IP address; and the determining module is further specifically configured to determine the GRE tunnel of the terminal according to the redetermined first endpoint IP address of the GRE tunnel and the second endpoint IP address of the GRE tunnel.

With reference to the fourth aspect or the first possible implementation manner of the fourth aspect, in a second possible implementation manner of the fourth aspect, the access site further includes: an association module, configured to associate the terminal IP address of the terminal with the gateway IP address, so that when the terminal accesses the access site next time, the GRE tunnel of the terminal is determined according to the gateway IP address.

With reference to the fourth aspect or any possible implementation manner of the first and the second possible implementation manner of the fourth aspect, in a third possible implementation manner of the fourth aspect, the gateway IP address determined by the determining module is an IP address of a second gateway device.

With reference to the fourth aspect or any possible implementation manner of the first to the third possible implementation manners of the fourth aspect, in a fourth possible implementation manner of the fourth aspect, the first gateway device includes a gateway control plane component and a gateway data plane component, the IP address of the first gateway device is an IP address of the gateway control plane component, and the gateway IP address determined by the determining module is an IP address of the gateway data plane component.

In conclusion, according to the method for determining a GRE tunnel, the gateway device, and the access site in the embodiments of the present invention, the gateway device assigns, to a terminal, a gateway IP address that is different from an IP address of the gateway device, so that the terminal can access a network by using another gateway device or gateway component, which can effectively reduce load of the gateway device.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for determining a GRE tunnel according to an embodiment of the present invention;

FIG. 2 is another schematic flowchart of a method for determining a GRE tunnel according to an embodiment of the present invention;

FIG. 3 is still another schematic flowchart of a method for determining a GRE tunnel according to an embodiment of the present invention;

FIG. 4 is a schematic flowchart of a method for determining a GRE tunnel according to another embodiment of the present invention;

FIG. 5 shows a schematic block diagram of a gateway device according to an embodiment of the present invention;

FIG. 6 shows a schematic block diagram of an access site according to an embodiment of the present invention;

FIG. 7 shows a schematic block diagram of a gateway device according to another embodiment of the present invention; and

FIG. 8 shows a schematic block diagram of an access site according to another embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

In the embodiments of the present invention, an access site may be a base station in a wireless local area network (WLAN″ for), or the access site may be a microcell (Microcell) base station, a picocell (Picocell) base station, or a home base station, or may be referred to as a femtocell (femtocell) or an access point (AP, Access Point), which is not limited in the present invention. For ease of understanding, the following describes actions of the access site by using an AP as an example.

It should further be understood that in the embodiments of the present invention, a terminal (Terminal) may be referred to as user equipment (UEt), a mobile station (MS), a mobile terminal (Mobile Terminal), or the like. The terminal may communicate with one or more core networks by using a radio access network (RAN). For example, the user equipment may be a mobile phone (also referred to as a “cellular” phone) or a computer with a mobile terminal For example, the user equipment may also be a portable, pocket-sized, handheld, computer built-in, or vehicle-mounted mobile apparatus, which exchanges voice and/or data with the radio access network.

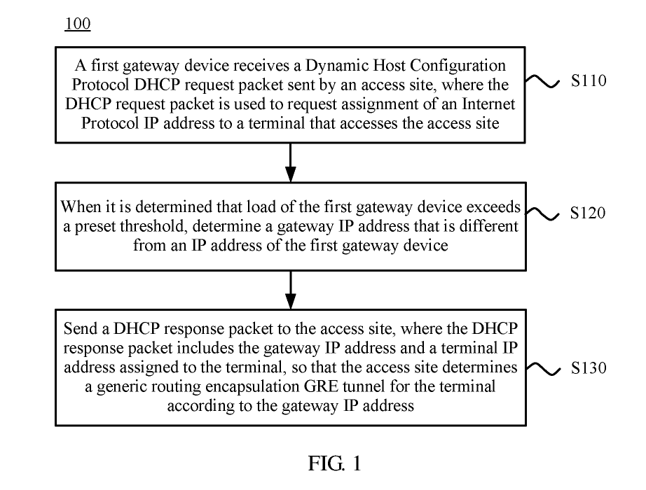

FIG. 1 shows a method 100 for determining a GRE tunnel according to an embodiment of the present invention, where the method 100 is executed by, for example, a first gateway device. As shown in FIG. 1, the method 100 includes the following steps:

S110. A first gateway device receives a Dynamic Host Configuration Protocol DHCP request packet sent by an access site, where the DHCP request packet is used to request assignment of an Internet Protocol IP address to a terminal that accesses the access site.

S120. When determining that load of the first gateway device exceeds a preset threshold, determine a gateway IP address that is different from an IP address of the first gateway device.

S130. Send a DHCP response packet to the access site, where the DHCP response packet includes the gateway IP address and a terminal IP address assigned to the terminal, so that the access site determines a generic routing encapsulation GRE tunnel of the terminal according to the gateway IP address.

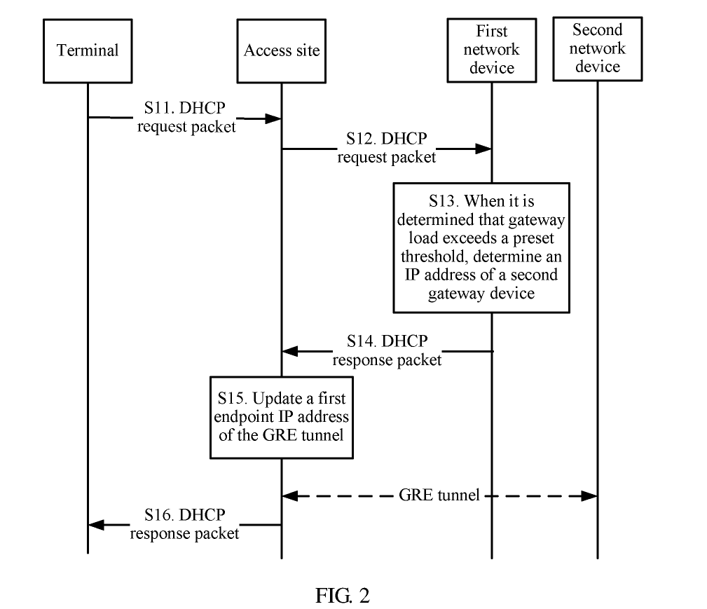

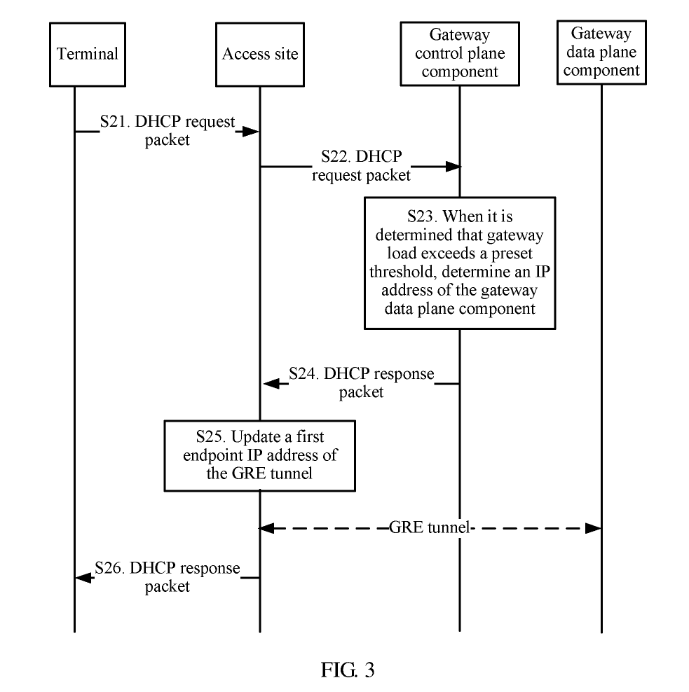

After the first gateway device receives the DHCP request packet, in addition to the Internet Protocol (IP) address assigned to the terminal, the DHCP response packet further includes the gateway IP address that is different from the IP address of the first gateway device, so that the access site determines the generic routing encapsulation GRE tunnel of the terminal according to the gateway IP address, which can effectively reduce the load of the first gateway device. Specifically, the gateway IP address may be an IP address of another gateway device, or may be an IP address of a data plane of the gateway device. The following describes in detail with reference to FIG. 2 and FIG. 3.

Therefore, in the method for determining a GRE tunnel in this embodiment of the present invention, a gateway device assigns, to a terminal, a gateway IP address that is different from an IP address of the gateway device, so that the terminal can access a network by using another gateway device or a gateway component, which can effectively reduce load of the gateway device.

In S120, when determining that the load exceeds the preset threshold, the first gateway device determines the gateway IP address that is different from the IP address of the first gateway device, so as to determine, for a connected terminal, a GRE tunnel whose tunnel endpoint IP address is different from the IP address of the first gateway device, that is, the terminal does not access a network by using the first gateway device, and can access the network by using another gateway device with less load.

Specifically, it is assumed that an access quantity that the first gateway device can bear is 100 k. When the access quantity exceeds 90 k, a current relatively idle second gateway device may be determined by using a preset policy, and an IP address of the second gateway device is determined as the gateway IP address. When the first gateway device receives a DHCP request packet from a terminal again, the gateway IP address is carried in a DHCP response packet. Alternatively, in a scenario in which a gateway device supports separation of a control plane and a data plane, the first gateway device may be understood as a gateway control plane component. When the gateway control plane component detects that its own access quantity exceeds the preset threshold, an IP address of a corresponding gateway data plane component is determined When next time the gateway control plane component receives a DHCP request packet sent by a terminal, the IP address of the gateway data plane component is carried in a DHCP response packet.

In this embodiment of the present invention, optionally, the determining a gateway IP address that is different from an IP address of the first gateway device includes:

determining an IP address of a second gateway device as the gateway IP address.

Specifically, as shown in FIG. 2, in S11, the terminal sends the DHCP request packet to the access site, where the DHCP request packet is used for requesting the IP address of the terminal; in S12, the access site forwards the DHCP request packet to the first gateway device; in S13, when determining that the gateway load exceeds the preset threshold, the first gateway device determines the IP address of the second gateway device as the gateway IP address of the terminal; in S14, the first gateway device sends the DHCP response packet to the access site, where the DHCP response packet includes the gateway IP address in addition to the terminal IP address assigned to the terminal by the first gateway device; in S15, the access site updates a first endpoint IP address of the GRE tunnel of the terminal according to the gateway IP address carried in the DHCP response packet, so that the GRE tunnel is determined for the terminal according to the first endpoint IP address of the GRE tunnel and an IP address of the access site; in S16, the access site forwards the DHCP response packet to the terminal, so that the terminal accesses a network according to the GRE tunnel.

It should be understood that, before the access site receives the DHCP response packet sent by the first gateway device, the IP address of the first gateway device has been determined as the first endpoint IP address of the GRE tunnel of the terminal, and the IP address of the access site has been determined as a second endpoint IP address of the GRE tunnel of the terminal, so that the GRE tunnel of the terminal is determined according to the first endpoint IP address of the GRE tunnel and the second endpoint IP address of the GRE tunnel. This part belongs to actions taken upon startup of the access site in the prior art, and for brevity, details are not described herein.

When the access site detects that the DHCP response packet sent by the first gateway device carries a gateway IP address that is different from the IP address of the first gateway device, the first endpoint IP address of the GRE tunnel of the terminal is updated according to the gateway IP address, and then a GRE tunnel is determined for the terminal according to an updated first endpoint IP address of the GRE tunnel and the second endpoint IP address of the GRE tunnel, that is, the IP address of the access site.

It should be understood that, in a scenario in which a control plane and a data plane of a gateway device are separated, an IP address of a gateway control plane component is different from that of a corresponding gateway data plane component. In this case, a gateway device that receives a DHCP request packet is actually the gateway control plane component, that is, the first gateway device in this embodiment of the present invention includes the gateway control plane component and the gateway data plane component, and the IP address of the first gateway device is the IP address of the gateway control plane component. After the first gateway device receives the DHCP request packet, the DHCP response packet sent to the access site may include the IP address of the corresponding gateway data plane component.

In this embodiment of the present invention, optionally, the first gateway device includes a gateway control plane component and a gateway data plane component, the IP address of the first gateway device is an IP address of the gateway control plane component, and the gateway IP address that is different from the IP address of the first gateway device is an IP address of the gateway data plane component.

Specifically, as shown in FIG. 3, in S21, the terminal sends the DHCP request packet to the access site, where the DHCP request packet is used for requesting the IP address of the terminal; in S22, the access site forwards the DHCP request packet to the gateway control plane component; in S23, when determining that the gateway load exceeds the preset threshold, the gateway control plane component determines the IP address of the corresponding gateway data plane component as the gateway IP address; in S24, the gateway control plane component sends the DHCP response packet to the access site, where the DHCP response packet includes the gateway IP address in addition to the IP address assigned to the terminal by the gateway control plane component; in S25, the access site updates a first endpoint IP address of the GRE tunnel of the terminal according to the gateway IP address carried in the DHCP response packet, so that a GRE tunnel is determined for the terminal according to the first endpoint IP address of the GRE tunnel and an IP address of the access site; in S26, the access site forwards the DHCP response packet to the terminal, so that the terminal accesses a network according to the GRE tunnel.

It should be understood that, the first gateway device may assign different gateway IP addresses according to DHCP request packets of different terminals, so that different GRE tunnels may be determined for different terminals of a same access site, and the different terminals access networks according to the different GRE tunnels. This can improve user experience on the one hand, and can effectively reduce the load of the first gateway device on the other hand. In addition, another gateway device is properly utilized, which can improve resource utilization.

It should be understood that, the gateway control plane component in FIG. 3 is corresponding to the first gateway device in this embodiment of the present invention.

It should further be understood that, the first gateway device may determine different gateway IP addresses for different terminals Specifically, for example, when a DHCP request packet of a first terminal is received, the IP address of the first gateway device is assigned to the first terminal as a gateway IP address of the first terminal; when a DHCP request packet of a second terminal is received, an IP address of a second gateway device is assigned to the second terminal as a gateway IP address of the second terminal; when a DHCP request packet of a third terminal is received, an IP address of a third gateway device is assigned to the third terminal as a gateway IP address of the third terminal; when a DHCP request packet of a fourth terminal is received, the IP address of the first gateway device is assigned to the fourth terminal as a gateway IP address of the fourth terminal; and when a DHCP request packet of a fifth terminal is received, the IP address of the second gateway device is assigned to the fifth terminal as a gateway IP address of the fifth terminal; by analogy in the following, that is, for successively received DHCP request packets of different terminals, a corresponding gateway IP address is selected from the IP addresses of the first gateway device, the second gateway device, and the third gateway device in a round-robin manner

It should be understood that, in this embodiment of the present invention, when the first gateway device determines that its own access load exceeds the preset threshold, an IP address that is different from the IP address of the first gateway device may be used as the gateway IP address of the terminal when the DHCP request packet is received again, so that the terminal accesses a network by using another gateway device or a gateway data plane component, thereby reducing the load of the first gateway device. It should be understood that, the first gateway device may assign the IP address that is different from the IP address of the first gateway device to the terminal by using different policies, which is not limited by this embodiment of the present invention.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

It should be understood that, in various embodiments of the present invention, sequence numbers of the foregoing processes do not mean execution sequences. The execution sequences of the processes should be determined according to functions and internal logic of the processes, and should not be construed as any limitation on the implementation processes of the embodiments of the present invention.

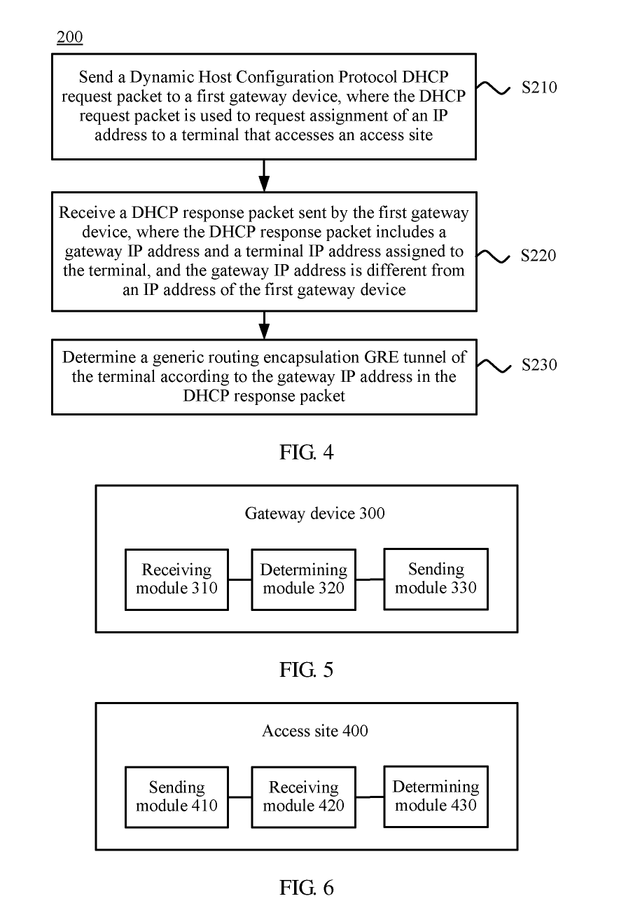

The method for determining a GRE tunnel according to this embodiment of the present invention is described above in detail from a perspective of the first gateway device with reference to FIG. 1 to FIG. 3, and a method for determining a GRE tunnel according to an embodiment of the present invention is described in the following from a perspective of an access site with reference to FIG. 4 to FIG. 5.

As shown in FIG. 4, a method 200 for determining a GRE tunnel according to this embodiment of the present invention may be executed by, for example, the access site, where the method 200 includes the following steps:

S210. Send a Dynamic Host Configuration Protocol DHCP request packet to a first gateway device, where the DHCP request packet is used to request assignment of an IP address to a terminal that accesses an access site.

S220. Receive a DHCP response packet sent by the first gateway device, where the DHCP response packet includes a gateway IP address and a terminal IP address assigned to the terminal, and the gateway IP address is different from an IP address of the first gateway device.

S230. Determine a generic routing encapsulation GRE tunnel of the terminal according to the gateway IP address in the DHCP response packet.

When the access site detects that the DHCP response packet sent by the first gateway device includes the gateway IP address, and the gateway IP address is different from the IP address of the first gateway device, a gateway IP address assigned to the terminal is updated to the gateway IP address, so that a GRE tunnel directed to a new gateway device is determined for the terminal, which can effectively reduce load of the first gateway device.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

It should be understood that, after the access site starts, the IP address of the first gateway device may be acquired from an access site controller by using a Dynamic Host Configuration Protocol (DHCP) process, and the IP address of the first gateway device is determined as a first endpoint IP address of the GRE tunnel by default, and an IP address of the access site is determined as a second endpoint IP address of the GRE tunnel.

In S220, the access site receives the DHCP response packet sent by the first gateway device, and when the access site detects that the DHCP response packet includes the gateway IP address, and the gateway IP address is different from the IP address of the first gateway device, a first endpoint IP address of the GRE tunnel originally assigned to the terminal is updated, that is, the gateway IP address in the DHCP response packet is determined as the first endpoint IP address of the GRE tunnel of the terminal, so that the terminal accesses a network by accessing another gateway device that is different from the first gateway device, which can effectively reduce the load of the first gateway device when there are a large quantity of users accessing the network.

In this embodiment of the present invention, optionally, before the receiving a DHCP response packet sent by the first gateway device, the method further includes:

determining the IP address of the first gateway device as a first endpoint IP address of the GRE tunnel of the terminal; and

determining an IP address of the access site as a second endpoint IP address of the GRE tunnel of the terminal; and

the determining a generic routing encapsulation GRE tunnel of the terminal includes:

redetermining a first endpoint IP address of the GRE tunnel of the terminal according to the DHCP response packet, where the redetermined first endpoint IP address of the GRE tunnel is the gateway IP address; and

determining the GRE tunnel of the terminal according to the redetermined first endpoint IP address of the GRE tunnel and the second endpoint IP address of the GRE tunnel.

After updating the first endpoint IP address of the GRE tunnel of the terminal, the access site may associate the gateway IP address with the terminal IP address of the terminal, so that when the terminal requests to access a network next time, the GRE tunnel is directly determined for the terminal according to the gateway IP address, which can effectively reduce load of the first gateway device.

In this embodiment of the present invention, optionally, the method further includes:

associating the terminal IP address of the terminal with the gateway IP address, so that when the terminal accesses the access site next time, the GRE tunnel of the terminal is determined according to the gateway IP address.

In this embodiment of the present invention, optionally, the gateway IP address is an IP address of a second gateway device.

In this embodiment of the present invention, optionally, the first gateway device includes a gateway control plane component and a gateway data plane component, the IP address of the first gateway device is an IP address of the gateway control plane component, and the gateway IP address is an IP address of the gateway data plane component.

It should further be understood that, specifically, the access site may be a logic entity, such as an access point (AP), an access controller (AC), or a Fat AP, which is not limited in this embodiment of the present invention.

It should further be understood that, in various embodiments of the present invention, sequence numbers of the foregoing processes do not mean execution sequences. The execution sequences of the processes should be determined according to functions and internal logic of the processes, and should not be construed as any limitation on the implementation processes of the embodiments of the present invention.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

The method for determining a GRE tunnel according to this embodiment of the present invention is described above in detail with reference to FIG. 1 to FIG. 4, and a gateway device and an access site according to the embodiments of the present invention are described in detail in the following with reference to FIG. 5 to FIG. 6.

FIG. 5 shows a schematic block diagram of a gateway device 300 according to an embodiment of the present invention. As shown in FIG. 5, the gateway device 300 includes:

a receiving module 310, configured to receive a Dynamic Host Configuration Protocol DHCP request packet sent by an access site, where the DHCP request packet is used to request assignment of an Internet Protocol IP address to a terminal that accesses the access site;

a determining module 320, configured to: when determining that load of the gateway device exceeds a preset threshold, determine a gateway IP address that is different from an IP address of the gateway device; and

a sending module 330, configured to send a DHCP response packet to the access site, where the DHCP response packet includes the gateway IP address and a terminal IP address assigned to the terminal, so that the access site determines a generic routing encapsulation GRE tunnel of the terminal according to the gateway IP address.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

Optionally, in this embodiment of the present invention, the determining module is specifically configured to determine an IP address of a second gateway device as the gateway IP address.

Optionally, in this embodiment of the present invention, the first gateway device includes a gateway control plane component and a gateway data plane component, an IP address of the first gateway device is an IP address of the gateway control plane component, and the gateway IP address that is different from the IP address of the first gateway device is an IP address of the gateway data plane component.

It should be understood that the gateway device 300 according to this embodiment of the present invention may be corresponding to the first gateway device in the method for determining a GRE tunnel in the embodiments of the present invention, and the foregoing and other operations and/or functions of the modules of the gateway device 300 are respectively used to implement corresponding procedures of methods in FIG. 1 to FIG. 4. For brevity, details are not described herein again.

Therefore, according to the gateway device in this embodiment of the present invention, the gateway device assigns a gateway IP address that is different from an IP address of the gateway device, so that terminals that access a same access site can access a network by using different GRE tunnels, which can effectively reduce load of the gateway device.

The gateway device 300 according to this embodiment of the present invention is described above in detail with reference to FIG. 5, and an access site 400 according to an embodiment of the present invention is described in detail in the following with reference to FIG. 6.

FIG. 6 shows a schematic block diagram of an access site 400 according to this embodiment of the present invention, where the access site 400 includes:

a sending module 410, configured to send a Dynamic Host Configuration Protocol DHCP request packet to a first gateway device, where the DHCP request packet is used to request assignment of an IP address to a terminal that accesses the access site;

a receiving module 420, configured to receive a DHCP response packet sent by the first gateway device, where the DHCP response packet includes a gateway IP address and a terminal IP address assigned to the terminal, and the gateway IP address is different from an IP address of the first gateway device; and

a determining module 430, configured to determine a generic routing encapsulation GRE tunnel of the terminal according to the gateway IP address in the DHCP response packet.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

Optionally, in this embodiment of the present invention, the determining module is further configured to: before the receiving module receives the DHCP response packet sent by the first gateway device, determine the IP address of the first gateway device as a first endpoint IP address of the GRE tunnel of the terminal;

the determining module is further configured to determine an IP address of the access site as a second endpoint IP address of the GRE tunnel of the terminal;

the determining module is further specifically configured to redetermine a first endpoint IP address of the GRE tunnel of the terminal according to the DHCP response packet, where the redetermined first endpoint IP address of the GRE tunnel is the gateway IP address; and

the determining module is further specifically configured to determine the GRE tunnel of the terminal according to the redetermined first endpoint IP address of the GRE tunnel and the second endpoint IP address of the GRE tunnel.

Optionally, in this embodiment of the present invention, the access site further includes:

an association module 450, configured to associate the terminal IP address of the terminal with the gateway IP address, so that when the terminal accesses the access site next time, the GRE tunnel of the terminal is determined according to the gateway IP address.

Optionally, in this embodiment of the present invention, the gateway IP address determined by the determining module is an IP address of a second gateway device.

Optionally, in this embodiment of the present invention, the first gateway device includes a gateway control plane component and a gateway data plane component, the IP address of the first gateway device is an IP address of the gateway control plane component, and the gateway IP address determined by the determining module is an IP address of the gateway data plane component.

It should be understood that the access site 400 according to this embodiment of the present invention may be corresponding to the access site in the method for determining a GRE tunnel in the embodiments of the present invention, and the foregoing and other operations and/or functions of the modules of the access site 400 are respectively used to implement corresponding procedures of methods in FIG. 1 to FIG. 4. For brevity, details are not described herein again.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

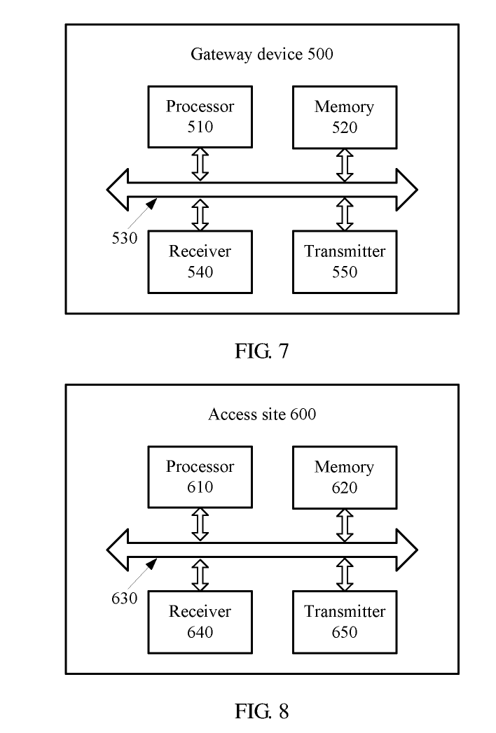

As shown in FIG. 7, an embodiment of the present invention further provides a gateway device 500, where the gateway device 500 includes a processor 510, a memory 520, a bus system 530, a receiver 540, and a transmitter 550. The processor 510, the memory 520, the receiver 540, and the transmitter 550 are connected to each other by using the bus system 530, the memory 520 is configured to store an instruction, and the processor 510 is configured to execute the instruction stored by the memory 520, so as to control the receiver 540 to receive a signal and control the transmitter 550 to send a signal. The receiver 540 is configured to receive a Dynamic Host Configuration Protocol DHCP request packet sent by an access site, where the DHCP request packet is used to request assignment of an Internet Protocol IP address to a terminal that accesses the access site; the processor 510 is configured to: when determining that load of the gateway device exceeds a preset threshold, determine a gateway IP address that is different from an IP address of the gateway device; the transmitter 550 is configured to send a DHCP response packet to the access site, where the DHCP response packet includes the gateway IP address and a terminal IP address assigned to the terminal, so that the access site determines a generic routing encapsulation GRE tunnel of the terminal according to the gateway IP address.

Therefore, according to the gateway device in this embodiment of the present invention, the gateway device assigns a gateway IP address that is different from an IP address of the gateway device, so that terminals that access a same access site can access a network by using different GRE tunnels, which can effectively reduce load of the gateway device.

It should be understood that, in this embodiment of the present invention, the processor 510 may be a central processing unit (CPU), or the processor 510 may be another general purpose processor, a digital signal processor (DSP), an application-specific integrated circuit (ASIC), a field programmable gate array (FPGA), or another programmable logical device, discrete gate or transistor logical device, discrete hardware component, or the like. The general purpose processor may be a microprocessor or the processor may be any conventional processor and the like.

The memory 520 may include a read-only memory and a random access memory, and provides an instruction and data to the processor 510. A part of the memory 520 may further include a non-volatile random access memory. For example, the memory 520 may further store device type information.

The bus system 530 may include a power bus, a control bus, a status signal bus, and the like in addition to a data bus. However, for clear description, various types of buses in the figure are marked as the bus system 530.

In an implementation process, the steps of the foregoing methods may be completed by means of an integrated logic circuit of hardware in the processor 510 or an instruction in a form of software. Steps of the methods disclosed with reference to the embodiments of the present invention may be directly executed and completed by means of a hardware processor, or may be executed and completed by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory 520, and the processor 510 reads information in the memory 520 and completes the steps of the foregoing methods in combination with hardware of the processor 510. To avoid repetition, details are not described herein again.

Optionally, in an embodiment, the processor 510 is specifically configured to determine an IP address of a second gateway device as the gateway IP address.

Optionally, in an embodiment, the processor 510 is further specifically configured to determine an IP address of a gateway data plane component corresponding to a first gateway device as the gateway IP address.

Optionally, in an embodiment, the first gateway device includes a gateway control plane component and a gateway data plane component, an IP address of the first gateway device is an IP address of the gateway control plane component, and the gateway IP address that is different from the IP address of the first gateway device is an IP address of the gateway data plane component.

It should be understood that, the gateway device 500 according to this embodiment of the present invention may be corresponding to the first gateway device in the method for determining a GRE tunnel in the embodiments of the present invention, and may also be corresponding to the gateway device 300 according to the embodiments of the present invention, and the foregoing and other operations and/or functions of the modules of the gateway device 500 are respectively used to implement corresponding procedures of methods in FIG. 1 to FIG. 4. For brevity, details are not described herein again.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

As shown in FIG. 8, an embodiment of the present invention further provides an access site 600, where the access site 600 includes a processor 610, a memory 620, a bus system 630, a receiver 640 and a transmitter 650. The processor 610, the memory 620, the receiver 640, and the transmitter 650 are connected to each other by using the bus system 630, the memory 620 is configured to store an instruction, and the processor 610 is configured to execute the instruction stored by the memory 620, so as to control the receiver 640 to receive a signal and control the transmitter 650 to send a signal. The transmitter 650 is configured to send a Dynamic Host Configuration Protocol DHCP request packet to a first gateway device, where the DHCP request packet is used to request assignment of an IP address to a terminal that accesses the access site; the receiver 640 is configured to receive a DHCP response packet sent by the first gateway device, where the DHCP response packet includes a gateway IP address and a terminal IP address assigned to the terminal, and the gateway IP address is different from an IP address of the first gateway device; and the processor 610 is configured to determine a generic routing encapsulation GRE tunnel of the terminal according to the gateway IP address in the DHCP response packet.

Therefore, according to the gateway device in this embodiment of the present invention, the gateway device assigns a gateway IP address that is different from an IP address of the gateway device, so that terminals that access a same access site can access a network by using different GRE tunnels, which can effectively reduce load of the gateway device.

It should be understood that, in this embodiment of the present invention, the processor 610 may be a central processing unit (CPU), or the processor 610 may be another general purpose processor, a digital signal processor (DSP), an application-specific integrated circuit (ASIC), a field programmable gate array (FPGA), or another programmable logical device, discrete gate or transistor logical device, discrete hardware component, or the like. The general purpose processor may be a microprocessor or the processor may be any conventional processor and the like.

The memory 620 may include a read-only memory and a random access memory, and provides an instruction and data to the processor 610. A part of the memory 620 may further include a non-volatile random access memory. For example, the memory 620 may further store device type information.

The bus system 630 may include a power bus, a control bus, a status signal bus, and the like in addition to a data bus. However, for clear description, various types of buses in the figure are marked as the bus system 630.

In an implementation process, the steps of the foregoing methods may be completed by means of an integrated logic circuit of hardware in the processor 610 or an instruction in a form of software. Steps of the methods disclosed with reference to the embodiments of the present invention may be directly executed and completed by means of a hardware processor, or may be executed and completed by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory 620, and the processor 610 reads information in the memory 620 and completes the steps of the foregoing methods in combination with hardware of the processor 610. To avoid repetition, details are not described herein again.

Optionally, in an embodiment, the processor 610 is further configured to: before the receiver receives the DHCP response packet sent by the first gateway device, determine the IP address of the first gateway device as a first endpoint IP address of the GRE tunnel of the terminal; the processor 610 is further configured to determine an IP address of the access site as a second endpoint IP address of the GRE tunnel of the terminal; the processor 610 is further configured to redetermine a first endpoint IP address of the GRE tunnel of the terminal according to the DHCP response packet, where the redetermined first endpoint IP address of the GRE tunnel is the gateway IP address; and the processor 610 is further configured to determine the GRE tunnel of the terminal according to the redetermined first endpoint IP address of the GRE tunnel and the second endpoint IP address of the GRE tunnel.

Optionally, in an embodiment, the processor 610 is further configured to associate the terminal IP address of the terminal with the gateway IP address, so that when the terminal accesses the access site next time, the GRE tunnel of the terminal is determined according to the gateway IP address.

Optionally, in an embodiment, the gateway IP address is an IP address of a second gateway device.

Optionally, in an embodiment, the first gateway device includes a gateway control plane component and a gateway data plane component, the IP address of the first gateway device is an IP address of the gateway control plane component, and the gateway IP address is an IP address of the gateway data plane component.

It should be understood that, the access site 600 according to this embodiment of the present invention may be corresponding to the access site in the method for determining a GRE tunnel in the embodiments of the present invention, and may also be corresponding to the access site 400 according to the embodiments of the present invention, and the foregoing and other operations and/or functions of the modules of the access site 600 are respectively used to implement corresponding procedures of methods in FIG. 1 to FIG. 4. For brevity, details are not described herein again.

Therefore, in the method for determining a GRE tunnel in this embodiment of the present invention, a gateway device assigns a gateway IP address that is different from an IP address of the gateway device, so that terminals that access a same access site can access a network by using different GRE tunnels, which can effectively reduce load of the gateway device.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or ” relationship between the associated objects.

It should be understood that, in various embodiments of the present invention, sequence numbers of the foregoing processes do not mean execution sequences. The execution sequences of the processes should be determined according to functions and internal logic of the processes, and should not be construed as any limitation on the implementation processes of the embodiments of the present invention.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for determining a GRE tunnel, comprising:
receiving, by a first gateway device, a Dynamic Host Configuration Protocol (DHCP) request packet sent by an access site, wherein the DHCP request packet is used to request assignment of an Internet Protocol (IP) address to a terminal that accesses the access site;
when determining that load of the first gateway device exceeds a preset threshold, determining a gateway IP address that is different from an IP address of the first gateway device; and
sending a DHCP response packet to the access site, wherein the DHCP response packet comprises the gateway IP address and a terminal IP address assigned to the terminal, so that the access site determines a generic routing encapsulation (GRE) tunnel of the terminal according to the gateway IP address.

2. The method according to claim 1, wherein the determining a gateway IP address that is different from an IP address of the first gateway device comprises:
determining an IP address of a second gateway device as the gateway IP address.

3. The method according to claim 1, wherein the first gateway device comprises a gateway control plane component and a gateway data plane component, the IP address of the first gateway device is an IP address of the gateway control plane component, and the gateway IP address that is different from the IP address of the first gateway device is an IP address of the gateway data plane component.

4. A method for determining a GRE tunnel, comprising:
sending a Dynamic Host Configuration Protocol DHCP request packet to a first gateway device, wherein the DHCP request packet is used to request assignment of an IP address to a terminal that accesses the access site;
receiving a DHCP response packet sent by the first gateway device, wherein the DHCP response packet comprises a gateway IP address and a terminal IP address assigned to the terminal, and the gateway IP address is different from an IP address of the first gateway device; and
determining a generic routing encapsulation GRE tunnel of the terminal according to the gateway IP address in the DHCP response packet.

5. The method according to claim 4, before the receiving a DHCP response packet sent by the first gateway device, the method further comprises:
determining the IP address of the first gateway device as a first endpoint IP address of the GRE tunnel of the terminal; and
determining an IP address of the access site as a second endpoint IP address of the GRE tunnel of the terminal; and
the determining a generic routing encapsulation GRE tunnel of the terminal comprises:
redetermining a first endpoint IP address of the GRE tunnel of the terminal according to the DHCP response packet, wherein the redetermined first endpoint IP address of the GRE tunnel is the gateway IP address; and
determining the GRE tunnel of the terminal according to the redetermined first endpoint IP address of the GRE tunnel and the second endpoint IP address of the GRE tunnel.

6. The method according to claim 4, wherein the method further comprises:
associating the terminal IP address of the terminal with the gateway IP address, so that when the terminal accesses the access site next time, the GRE tunnel of the terminal is determined according to the gateway IP address.

7. The method according to claim 4, wherein the gateway IP address is an IP address of a second gateway device.

8. The method according to claim 4, wherein the first gateway device comprises a gateway control plane component and a gateway data plane component, the IP address of the first gateway device is an IP address of the gateway control plane component, and the gateway IP address is an IP address of the gateway data plane component.

9. A gateway device, comprising:
a receiver, configured to receive a Dynamic Host Configuration Protocol DHCP request packet sent by an access site, wherein the DHCP request packet is used to request assignment of an Internet Protocol IP address to a terminal that accesses the access site;
a processor, configured to: when determining that load of the gateway device exceeds a preset threshold, determine a gateway IP address that is different from an IP address of the gateway device; and
a sender, configured to send a DHCP response packet to the access site, wherein the DHCP response packet comprises the gateway IP address and a terminal IP address assigned to the terminal, so that the access site determines a generic routing encapsulation GRE tunnel of the terminal according to the gateway IP address.

10. The gateway device according to claim 9, wherein the determining module is specifically configured to determine an IP address of a second gateway device as the gateway IP address.

11. The gateway device according to claim 9, wherein the gateway device comprises a gateway control plane component and a gateway data plane component, an IP address of the gateway device is an IP address of the gateway control plane component, and the gateway IP address that is different from the IP address of the gateway device is an IP address of the gateway data plane component.

12. An access site, comprising:
a sender, configured to send a Dynamic Host Configuration Protocol DHCP request packet to a first gateway device, wherein the DHCP request packet is used to request assignment of an IP address to a terminal that accesses the access site;
a receiver, configured to receive a DHCP response packet sent by the first gateway device, wherein the DHCP response packet comprises a gateway IP address and a terminal IP address assigned to the terminal, and the gateway IP address is different from an IP address of the first gateway device; and
a processor, configured to determine a generic routing encapsulation GRE tunnel of the terminal according to the gateway IP address in the DHCP response packet.

13. The access site according to claim 12, wherein the processor is further configured to: before the receiving module receives the DHCP response packet sent by the first gateway device, determine the IP address of the first gateway device as a first endpoint IP address of the GRE tunnel of the terminal;
the processor is further configured to determine an IP address of the access site as a second endpoint IP address of the GRE tunnel of the terminal;
the processor is further specifically configured to redetermine a first endpoint IP address of the GRE tunnel of the terminal according to the DHCP response packet, wherein the redetermined first endpoint IP address of the GRE tunnel is the gateway IP address; and
the processor is further specifically configured to determine the GRE tunnel of the terminal according to the redetermined first endpoint IP address of the GRE tunnel and the second endpoint IP address of the GRE tunnel.

14. The access site according to claim 12, wherein
the processor, configured to associate the terminal IP address of the terminal with the gateway IP address, so that when the terminal accesses the access site next time, the GRE tunnel of the terminal is determined according to the gateway IP address.

15. The access site according to claim 12, wherein the gateway IP address determined by the determining module is an IP address of a second gateway device.

16. The access site according to claim 12, wherein the first gateway device comprises a gateway control plane component and a gateway data plane component, the IP address of the first gateway device is an IP address of the gateway control plane component, and the gateway IP address determined by the determining module is an IP address of the gateway data plane component.
